(19) United States
(12) Patent Application Publication
(10) Pub. No.: US 2015/0343437 A1
(43) Pub. Date: Dec. 3, 2015

(54) DUCT DEVICE

(71) Applicant: Panasonic Intellectual Property Management Co., Ltd., Osaka (JP)

(72) Inventors: YUSUKE KITAGAWA, Kyoto (JP); KIYOSHI HASHIMOTODANI, Kyoto (JP); AKIHIKO TAKADA, Hyogo (JP)

(21) Appl. No.: 14/759,166

(22) PCT Filed: Dec. 26, 2013
(86) PCT No.: PCT/JP2013/007618

§ 371 Date: Jul. 2, 2015

(30) Foreign Application Priority Data
Jan. 7, 2013 (JP) 2013-000301

(51) Int. Cl. B01L 3/00

(52) U.S. Cl. CPC B01L 3/502; B01L 2300/0848; B01L 2300/0877; B01L 2300/0832

(57) ABSTRACT

A flow channel device includes the following elements: an introduction region for receiving a specimen into the flow channel; a discharge region for discharging the specimen; and a trap body between the introduction region and the discharge region. In the trap body formed in the flow channel, the lateral area of the lateral side surface of the trap body facing the introduction region side is larger than the projected area of the lateral side surface of the trap body projected along the flow channel from the introduction region side toward the discharge region side with respect to the trap body.

### TECHNICAL FIELD

The present invention relates to a flow channel device that can be used for detecting viruses, for example.

### BACKGROUND ART

FIG. 11 is a sectional view of conventional flow channel device 700 for detecting hybridization. Flow channel device 700 includes the following elements: flow channel 703 having injection port 701 and discharge port 702 at respective ends; and weir 704 disposed in flow channel 703. In flow channel 703, narrow portion 706 is formed by weir 704.

Flow channel device 700 is used for detecting DNA hybridization. Each of microbeads 705 is modified with a nucleotide chain for hybridization to a DNA as a target object of detection. Microbeads 705 flowing in flow channel 703 cannot go through narrow portion 706, and accumulate on weir 704 on the side of injection port 701. Through observation of microbeads 705 accumulated by weir 704, the user detects whether DNA hybridization has occurred.

As a prior art document related to this invention, Non-Patent Literature 1, for example, is known.

### CITATION LIST

### Non-Patent Literature

NPTL1: Joohoon Kim, “Hybridization of DNA to Bead-Immobilized Probes Confined within a Microfluidic Channel”, Langmuir, American Chemical Society, Oct. 24, 2006, Vol. 22, No. 24, pp. 10130-10134

### SUMMARY OF THE INVENTION

A first flow channel device of the present invention includes the following elements:

an introduction region for receiving a specimen;

a discharge region for discharging the specimen;

a tubular flow channel; and

a trap body.

The periphery of the tubular flow channel is surrounded by wall surfaces. The trap body is provided in the region between the introduction region and the discharge region in the flow channel so that a narrow portion is formed in the flow channel. The trap body has a lateral side surface facing the introduction region side. The area of the lateral side surface of the trap body is larger than the projected area of the lateral side surface projected along the flow channel from the introduction region side toward the discharge region side with respect to the trap body.

A second flow channel device of the present invention includes the following elements:

an introduction region for receiving a specimen;

a discharge region for discharging the specimen;

a tubular flow channel; and

a trap body.

The periphery of the tubular flow channel is surrounded by wall surfaces. The trap body is provided in the region between the introduction region and the discharge region in the flow channel so that a narrow portion is formed in the flow channel. The trap body has a lateral side surface facing the introduction region side. The lateral side surface of the trap body includes a portion that is non-parallel to the flow channel section perpendicular to the flow direction in the region having the trap body formed therein.

### BRIEF DESCRIPTION OF DRAWINGS

FIG. 1A is a top view showing a schematic configuration of a flow channel device in accordance with a first exemplary embodiment of the present invention.

FIG. 1B is a side sectional view showing a schematic configuration of the flow channel device in accordance with the first exemplary embodiment.

FIG. 2A is a side sectional view showing a main configuration of the flow channel device shown in FIG. 1B.

FIG. 2B is a sectional view from the top showing a main configuration of the flow channel device shown in FIG. 1A.

FIG. 3 is a side sectional view schematically showing the operation of a trap body and target objects of detection in the flow channel device shown in FIG. 1B.

FIG. 4 is a diagram showing an example of a projection plane of a lateral side surface of the trap body facing an introduction region side.

FIG. 5 is a side sectional view showing another trap body in accordance with the first exemplary embodiment of the present invention.

FIG. 6A is a sectional view from the top schematically showing the operation of the trap body and target objects of detection in the flow channel device shown in FIG. 1A.

FIG. 6B is a sectional view from the top schematically showing the operation of a conventional flow channel device.

FIG. 7 is a sectional view from the top of a trap body of a flow channel device in accordance with a second exemplary embodiment.

FIG. 8 is a sectional view from the top of a trap body of a flow channel device in accordance with a third exemplary embodiment.

FIG. 9 is a sectional view from the top of a trap body of a flow channel device in accordance with a fourth exemplary embodiment.

FIG. 10 is a side sectional view of a flow channel device in accordance with a fifth exemplary embodiment.

FIG. 11 is a side sectional view schematically showing a conventional flow channel device.

### DESCRIPTION OF EMBODIMENTS

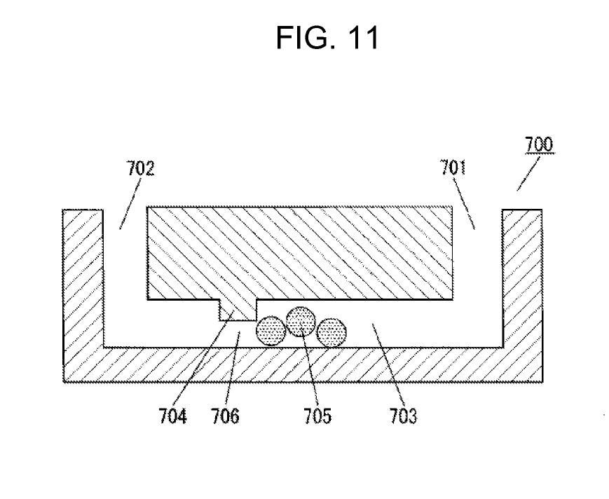

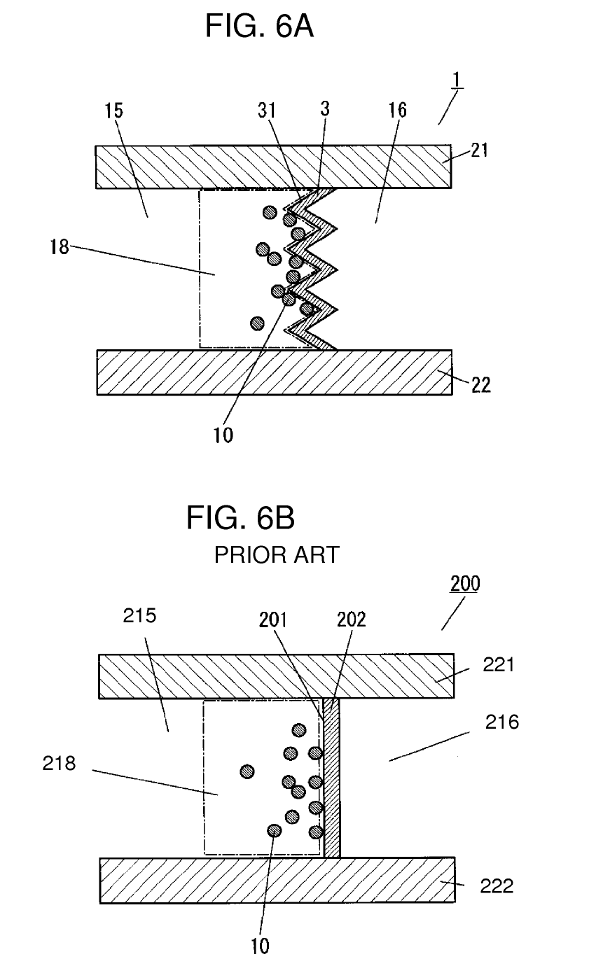

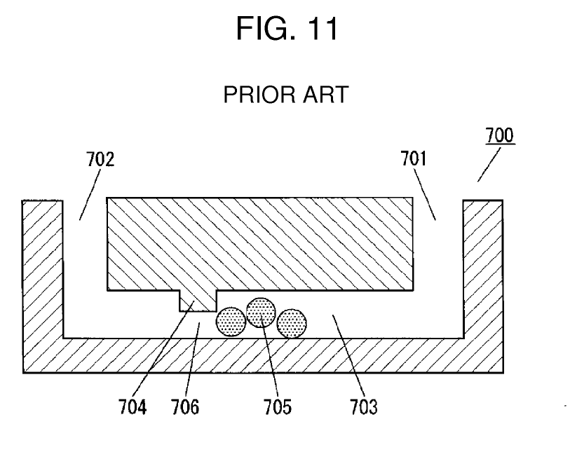

Prior to the explanation of exemplary embodiments of the present invention, a description is provided for problems in conventional flow channel device 700 shown in FIG. 11. Flow channel device 700 needs to have a microstructure in a nanoscale. However, in flow channel device 700 having a microstructure, narrow portion 706 is easily clogged with target objects of detection. This rapidly increases the flow channel resistance, thereby causing a sluggish flow. Forcedly causing a flow in flow channel 703 requires a mechanism for producing a high pressure that overcomes the flow channel resistance. This makes the chip structure complicated. Hereinafter, a description is provided for exemplary embodiments that address the above problems.

### First Exemplary Embodiment

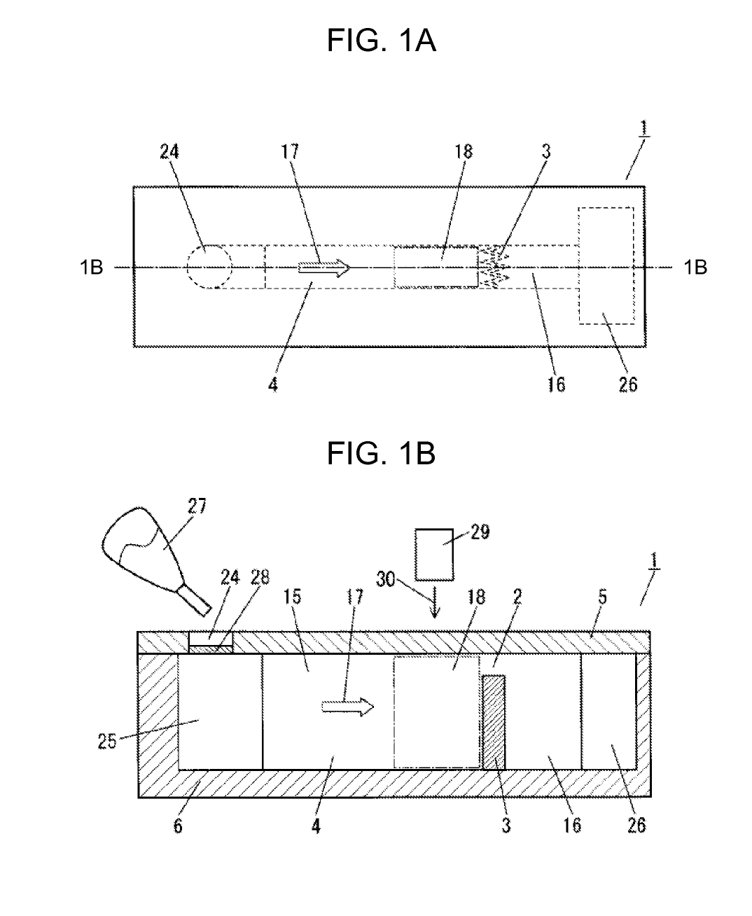

FIG. 1A is a top view showing a schematic configuration of flow channel device 1 in accordance with the first exemplary embodiment of the present invention. FIG. 1B is a side sectional view taken along line 1B-1B in FIG. 1B.

Flow channel device 1 includes flow channel 4 that includes introduction region 15 for receiving a specimen and discharge region 16 for discharging the specimen. Flow channel 4 has a tubular shape in which the periphery is surrounded by wall surfaces. Trap body 3 is provided in the region between introduction region 15 and discharge region 16 in flow channel 4 so that narrow portion 2 is formed in flow channel 4. Trap body 3 has a lateral side surface facing the side of introduction region 15.

The area of the lateral side surface of trap body 3 facing the side of introduction region 15 is larger than the projected area of the lateral side surface of trap body 3 projected along flow channel 4 from the side of introduction region 15 toward the side of discharge region 16.

A specimen flows from introduction region 15 toward discharge region 16. The specimen is injected from injection port 24 formed upstream of introduction region 15. The injected specimen is reserved once in reservoir 25. The examined specimen having gone through discharge region 16 is reserved in reservoir 26.

The user injects the specimen to be examined from injection port 24 into reservoir 25, using dropper 27, for example. The specimen is a solution of biological origin, such as blood and saliva.

The specimen reserved in reservoir 25 is introduced into introduction region 15 of flow channel 4 through a capillary action, for example. The specimen introduced into flow channel 4 flows in the direction of arrow 17 in flow channel 4, is discharged from discharge region 16 via trap part 18, and is reserved in reservoir 26. At that time, target objects of detection contained in the specimen are trapped by narrow portion 2 formed by trap body 3 in the flow channel and are accumulated in trap part 18.

The walls that form flow channel 4 are made of transparent material, such as glass, resin, silicon, and transparent plastic that efficiently transmit light.

Trap body 3 is formed of glass, resin, silicon, transparent plastic, metal, or the like. The wall and trap body 3 may be made by bonding separately formed elements, or may be integrally formed.

Electromagnetic wave source 29 is disposed above top wall 5, i.e. in the direction opposite to bottom wall 6 with respect to top wall 5. Electromagnetic wave source 29 radiates electromagnetic waves 30 to trap part 18 from the upper direction of top wall 5.

The target objects of detection accumulated in trap part 18 are detected by electromagnetic waves 30 radiated to flow channel device 1. When electromagnetic waves 30 are radiated to trap part 18, flow channel device 1 or a target object of detection reflects or radiates the electromagnetic waves, such as light. A sensor (not shown) senses the electromagnetic waves, such as light, reflected or radiated from flow channel device 1 or the target object of detection. Thereby, the user detects the target object of detection.

Here, preferably, electromagnetic waves 30 are visible light. When electromagnetic waves 30 are visible light, the sensor is not always necessary. The eyes of the user can detect the target object of detection in the specimen by sensing changes in the color and intensity of the electromagnetic waves.

The target object of detection indicates matter that clogs narrow portion 2 in flow channel 4 and accumulates in trap part 18. Specifically, examples of the target object of detection include the following substances: a particle having a diameter larger than narrow portion 2, such as a bead contained in the specimen; and an aggregate that is formed of combined fine particles each having a diameter smaller than narrow portion 2 and thus has a diameter larger than narrow portion 2. Each fine particle that forms an aggregate is immobilized by an acceptor specifically binding to an object to be measured. Examples of the object to be measured include a virus contained in a specimen. When viruses are contained in the specimen, the fine particles each of which is immobilized by a specific acceptor bind to the viruses, form an aggregate, and accumulate in the trap part. The fine particles each of which is immobilized by an acceptor specifically binding to the object to be measured in the specimen and allowing formation of an aggregate may be disposed on a wall surface of flow channel 4 or may be contained in the specimen.

An acceptor indicates a capturing body specifically binding to an object to be measured. Examples of the acceptor include antibody, receptor protein, aptamer, porphyrin, and a polymer produced by molecular imprinting technology.

As shown in FIG. 1B, preferably, filter 28 is disposed between injection port 24 and reservoir 25. Filter 28 is capable of removing unnecessary substances, such as dust, mixed in the specimen.

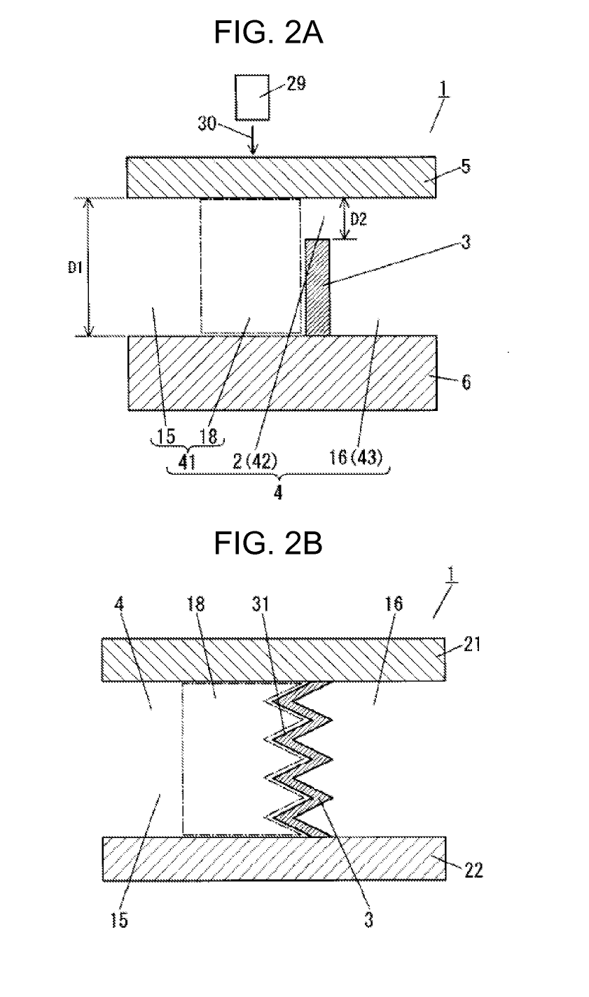

Next, a description is provided for the detailed configuration of trap body 3 in flow channel device 1 and the operation principle in which target objects of detection is trapped, with reference to FIG. 2A through FIG. 6B. FIG. 2A is a side sectional view showing a main configuration of flow channel device 1. FIG. 2B is a sectional view from the top showing a main configuration of flow channel device 1.

As shown in FIG. 2A, flow channel device 1 has top wall 5 and bottom wall 6 opposed to each other with flow channel 4 interposed therebetween. Trap body 3 for trapping target objects of detection is provided in flow channel 4. Flow channel device 1 also has side wall 21 and side wall 22 opposed to each other with flow channel 4 interposed therebetween. Thus, tubular flow channel 4 is formed of four surrounding wall surfaces, i.e. bottom surface 5A of top wall 5, top surface 6A of bottom wall 6, side surface 21A of side wall 21, and side surface 22A of side wall 22.

As shown in FIG. 2A, narrow portion 2 is formed by top wall 5 and trap body 3 in flow channel 4. Flow channel 4 includes the following elements: introduction region 15 for receiving a specimen; discharge region 16 for discharging the specimen; and trap part 18, provided on the side nearer to introduction region 15 than trap body 3, for accumulating target objects of detection. In other words, flow channel 4 is composed of a flow channel (first flow channel 41) formed of introduction region 15 and trap part 18, a flow channel (second flow channel 42) formed of narrow portion 2, and a flow channel (third flow channel 43) formed of discharge region 16. Flow channel 4 is formed so that the height of second flow channel 42 (a space between top wall 5 and trap body 3) is smaller than the height of first flow channel 41 (a space between top wall 5 and bottom wall 6). That is, in flow channel 4, height D1 of first flow channel 41 is larger than height D2 of second flow channel 42. When a specimen is introduced in flow channel 4, the specimen flows from introduction region 15 toward discharge region 16; thereby target objects of detection in the specimen move toward discharge region 16.

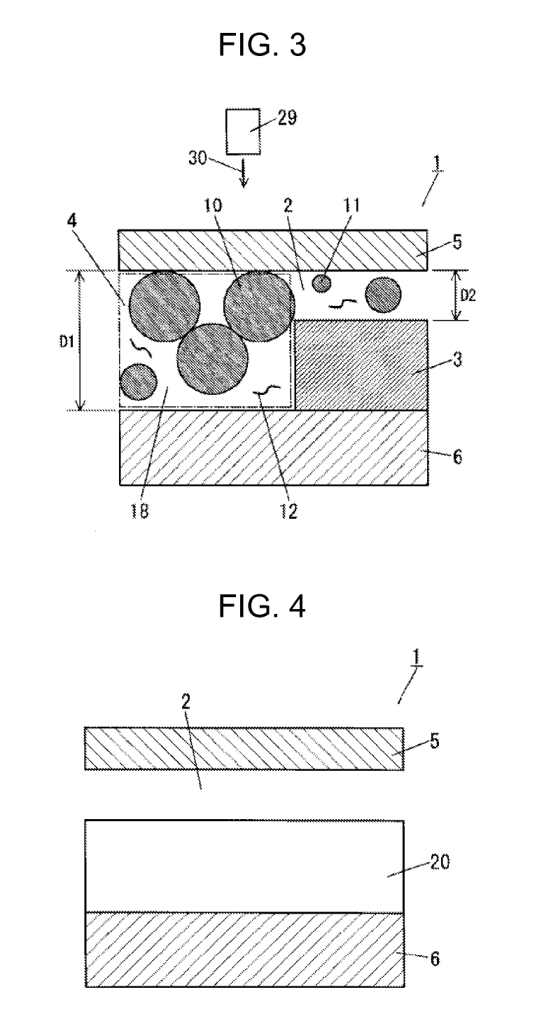

FIG. 3 is an enlarged view of trap part 18. Height D2 of the flow channel is smaller than the diameter of target object 10 to be trapped that is contained in the specimen.

In such flow channel 4, target object 10 having a diameter larger than D2 is caught at the entrance of narrow portion 2 of flow channel 4 and accumulated in trap part 18. Then, flow channel 4 is clogged with target object 10 having been captured, and target object 10 flowing next accumulates in trap part 18. That is, non-target object 11 having a diameter equal to or smaller than D2, medium 12, a solution, or the like in the specimen can go through narrow portion 2. However, target object 10 having a diameter larger than D2 cannot go through narrow portion 2. Thus, target object 10 having a diameter larger than D2 is accumulated in trap part 18.

As shown in FIG. 2B, lateral side surface 31 of trap body 3 facing the side of the introduction region is formed of a plurality of planes, for example, and has a shape in which part of the planes projects toward introduction region 15. The lateral side surface has one or a plurality of projections so that a gap is provided between each tip and the tip of the adjacent projection. The gap may be larger or smaller than target object 10. Any angle may be formed with respect to the adjacent projection. Target object 10 in the specimen is captured in this angled portion.

Here, lateral side surface 31 of trap body 3 facing the side of introduction region 15 indicates the surface in which the outward normal vector on the surface of trap body 3 has a component in the direction toward the side of introduction region 15 of flow channel 4.

FIG. 4 shows projection plane 20 of lateral side surface 31 of trap body 3 facing the side of introduction region 15. This projection plane is obtained by projecting trap body 3 along the flow channel from the side of introduction region 15 toward the side of discharge region 16.

Trap body 3 is formed so that lateral surface area S1 of lateral side surface 31 of trap body 3 on the side of introduction region 15 is larger than area S2 of projection plane 20 of lateral side surface 31 projected along flow channel 4 from the side of introduction region 15 toward the side of discharge region 16 with respect to trap body 3.

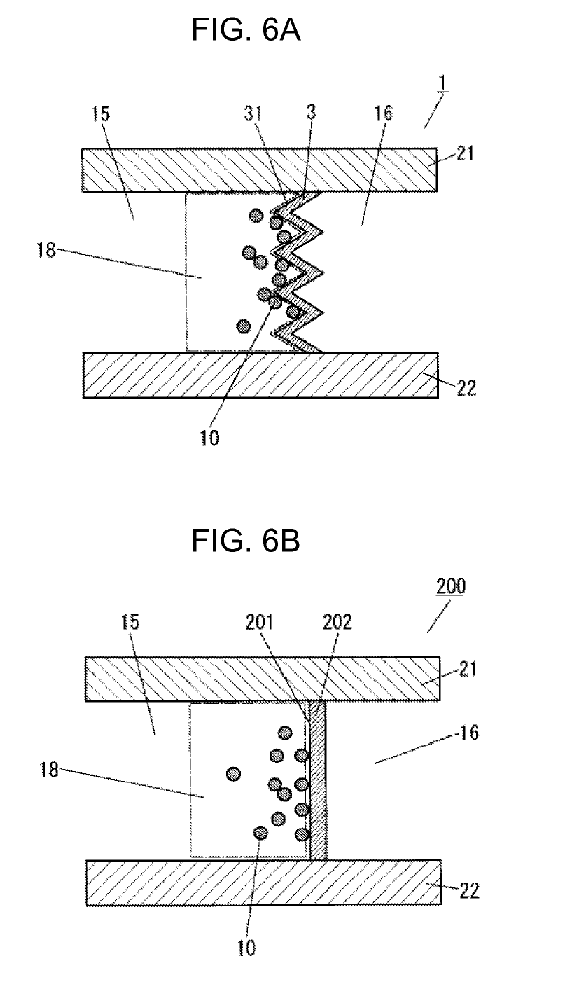

In other words, lateral side surface 31 of trap body 3 facing the side of introduction region 15 has a portion non-parallel to the flow channel section perpendicular to the flow direction in flow channel 4 in the region having trap body 3 formed therein. Here, the state where lateral side surface 31 of trap body 3 is parallel to the flow channel section perpendicular to the flow direction in flow channel 4 indicates the shape of lateral side surface 201 of trap body 202 facing the side of introduction region 15 shown in FIG. 6B, for example.

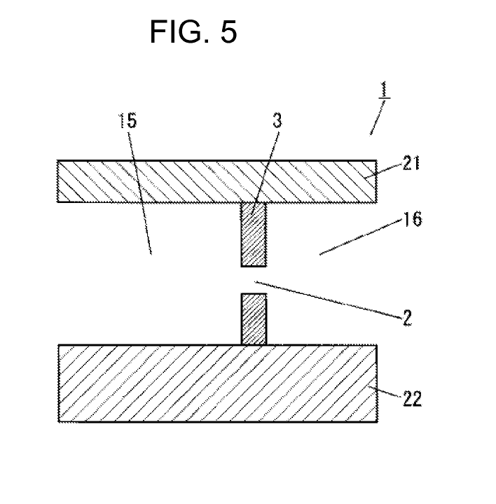

As shown in FIG. 2A, the position of narrow portion 2 provided in flow channel 4 is set along top wall 5 of flow channel 4. However, the position is not limited to the above, and the narrow portion may be disposed along bottom wall 6 or one of side walls 21, 22. As shown in the side sectional view of flow channel device 1 of FIG. 5, narrow portion 2 in flow channel 4 may be disposed in the vicinity of the center of flow channel 4. That is, narrow portion 2 is not necessarily along the walls constituting flow channel 4.

Flow channel 4 has been described, using tubular flow channel 4 surrounded by four surfaces including a top wall surface and a bottom wall surface. However, the sectional shape of flow channel 4 may be substantially a circle, or a polygon, such as a triangle and a square, as long as the periphery of flow channel 4 is closed by wall surfaces.

FIG. 6A is a sectional view from the top showing the operation of the flow channel device. FIG. 6A is a diagram showing the operation when a specimen containing target objects 10 are made flow in flow channel device 1 shown in FIG. 2B. FIG. 6B is a sectional view from the top showing the operation of flow channel device 200 as a comparative example of the operation. Flow channel device 200 has trap body 202 in the flow channel. Trap body 202 has lateral side surface 201 facing the side of introduction region 215. Area S4 of the projection plane of lateral side surface 201 projected along the flow channel from the side of introduction region 215 toward the side of discharge region 216 with respect to trap body 202 is equal to lateral surface area S3 of lateral side surface 201.

The specimen that contains target objects 10 flowing in the flow channels moves from the side of introduction regions 15, 215 toward trap bodies 3, 202, respectively. When the specimen containing target objects 10 reaches trap bodies 3, 202, also as shown in FIG. 3, non-target object 11 having a diameter smaller than D2, medium 12, and a solution go through narrow portions 2 and flow toward discharge regions 16, 216, respectively. In contrast, target objects 10 each having a diameter larger than D2 cannot go through the narrow portions in the flow channels and accumulate in trap parts 18, 218.

Here, with reference to FIG. 6A and FIG. 6B, the areas of lateral side surfaces 31, 201 of trap bodies 3, 202 formed in the flow channels so as to face the sides of introduction regions 15, 215 are compared with each other.

In the case of flow channel device 200 shown in FIG. 6B, lateral side surface 201 of trap body 202 facing the side of introduction region 215 is formed perpendicularly to the flow direction in the flow channel, and has an area obtained by the width of the flow channel between side wall 221 and side wall 222. Flow channel device 1 shown in FIG. 6A has two or more planes in lateral side surface 31 of trap body 3 facing the side of introduction region 15. In flow channel device 1, adjacent planes form projections. Thus, lateral side surface 31 of trap body 3 facing the side of introduction region 15 is formed of two or more planes and adjacent planes form projections. Thereby, lateral side surface 31 of trap body 3 facing the side of introduction region 15 has an area larger than that obtained by the width of the flow channel. That is, when area S2 of the projection plane of lateral side surface 31 shown in FIG. 6A is equal to area S4 of the projection plane of lateral side surface 201 shown in FIG. 6B, area S1 of the lateral side surface of the trap body on the side of introduction region 15 is larger than S3.

When the diameter of target object 10 is smaller than the gap between the tips of adjacent projections in trap body 3, target object 10 enters an angled portion. In trap body 3, the vicinities of the tips of the projections projecting on the side of introduction region 15 are less likely to be clogged with target objects 10. Thus, depending on the place, trap body 3 has a portion that makes narrow portion 2 likely to be clogged with target objects 10 and a portion that makes the narrow portion less likely to be clogged with target objects. Therefore, trap body 3 allows more passage of the specimen in narrow portion 2 than trap body 202 that has straight lateral side surface 201 disposed perpendicularly to the flow direction shown in FIG. 6B. This can reduce an increase in the flow channel resistance caused by clogging of the specimen. Reducing a rapid increase in the flow channel resistance allows the specimen to flow from the side of introduction region 15 toward the side of discharge region 16 even in the state where target objects 10 are trapped in trap body 3 to a certain degree. Thus, more target objects 10 can be captured in trap part 18.

When the diameter of target object 10 is larger than the gap between the tips of adjacent projections of trap body 3, target object 10 does not enter the gap in trap body 3, and is captured at the tip of the projection. In this case, the specimen goes around from the top and bottom directions of target object 10 and can go through narrow portion 2. This can reduce an increase in the flow channel resistance caused by clogging of the specimen. Reducing a rapid increase in the flow channel resistance allows the specimen to flow from the side of introduction region 15 toward the side of discharge region 16 even in the state where target objects 10 are trapped in trap body 3 to a certain degree. Thus, more target objects 10 can be captured in trap part 18.

Increasing the amount of accumulating target objects 10 in this manner enhances the sensitivity of detecting target objects 10, thus allowing detection using a more simplified detecting device.

### Second Exemplary Embodiment

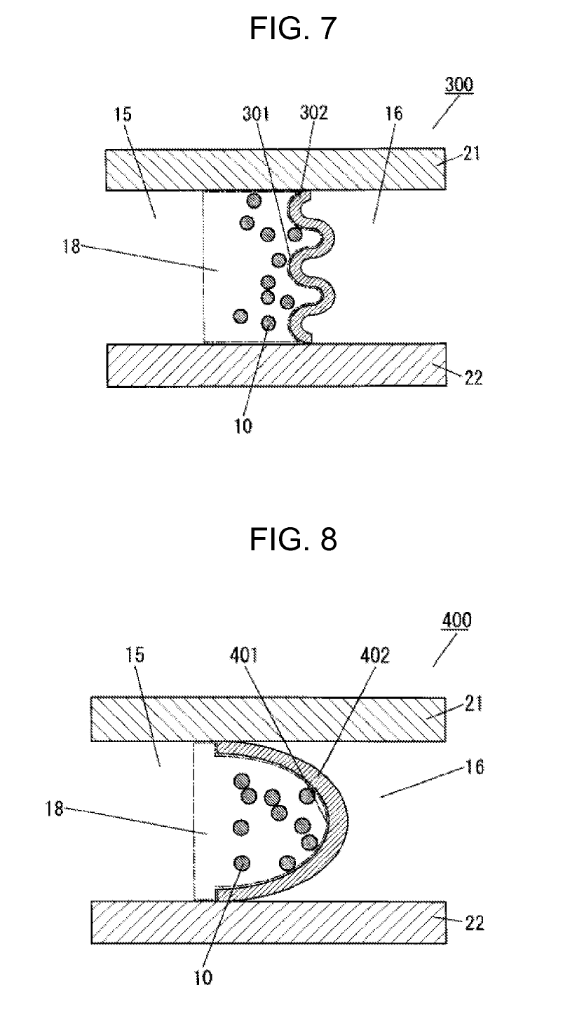

Next, a description is provided for flow channel device 300 in accordance with the second exemplary embodiment of the present invention, with reference to FIG. 7. FIG. 7 is a sectional view from the top of flow channel device 300. In this exemplary embodiment, elements similar to those of the first exemplary embodiment have the same reference marks and the descriptions of those elements are omitted in some cases.

In flow channel device 300, lateral side surface 301 of trap body 302 facing the side of introduction region 15 has a wavy surface. One or a plurality of waves may be provided. In FIG. 7, the entire part of lateral side surface 301 has a wavy shape, but only part of the lateral side surface may have a wavy shape. That is, in trap body 302, the edge of lateral side surface 301 facing narrow portion 2 has a wavy line.

The space between the waves formed in lateral side surface 301 of trap body 302 may be larger or smaller than target object 10. The spaces between the waves formed in lateral side surface 301 may be the same or different.

Trap body 302 is formed so that lateral area S5 of lateral side surface 301 of trap body 302 on the side of introduction region 15 is larger than area S6 of the projection plane of lateral side surface 301 projected along flow channel 4 from the side of introduction region 15 toward the side of discharge region 16 with respect to trap body 302.

In the case of flow channel device 300, lateral side surface 301 formed into a wavy surface has area S5 larger than that obtained by the width of the flow channel between side wall 21 and side wall 22. That is, when area S6 of the projection plane of lateral side surface 301 shown in FIG. 7 is equal to area S4 of the projection plane of lateral side surface 201 shown in FIG. 6B, area S5 of the lateral side surface of trap body 302 on the side of introduction region 15 is larger than area S3.

When the diameter of target object 10 is smaller than the space between the waves formed in lateral side surface 301, target object 10 enters a concave portion. However, in trap body 302, the vicinities of convex portions protruding on the side of introduction region 15 are less likely to be clogged with target objects 10. Here, the concave portions in trap body 302 are the portions where the waves protrude to the side of discharge region 16 and the convex portions indicate the portions where the waves protrude to the side of introduction region 15. In this manner, depending on the place, trap body 302 has a portion that makes narrow portion 2 likely to be clogged with target objects and a portion that makes the narrow portion less likely to be clogged with target objects. Thus, trap body 302 allows more passage of the specimen in narrow portion 2 than trap body 202 that has straight lateral side surface 201 disposed perpendicularly to the flow direction shown in FIG. 6B. This can reduce an increase in the flow channel resistance caused by clogging of the specimen. Reducing a rapid increase in the flow channel resistance allows the specimen to flow from the side of introduction region 15 toward the side of discharge region 16 even in the state where target objects 10 are trapped in trap body 302 to a certain degree. Thus, more target objects 10 can be captured in trap part 18.

When the diameter of target object 10 is larger than the space between the waves formed in lateral side surface 301, target object 10 does not enter a concave portion in trap body 302, and is captured in a convex portion adjacent to the concave portion. In this case, the specimen goes around from the top and bottom directions of target object 10 and can go through narrow portion 2. This can reduce an increase in the flow channel resistance caused by clogging of the specimen. Reducing a rapid increase in the flow channel resistance allows the specimen to flow from the side of introduction region 15 toward the side of discharge region 16 even in the state where target objects 10 are trapped in trap body 302 to a certain degree. Thus, more target objects 10 can be captured in trap part 18.

Increasing the amount of accumulating target objects 10 in this manner enhances the sensitivity of detecting target objects 10, thus allowing detection using a more simplified detecting device.

### Third Exemplary Embodiment

Next, a description is provided for flow channel device 400 in accordance with the third exemplary embodiment of the present invention, with reference to FIG. 8. FIG. 8 is a sectional view from the top of flow channel device 400. In this exemplary embodiment, elements similar to those of the first exemplary embodiment have the same reference marks and the descriptions of those elements are omitted in some cases.

In flow channel device 400, lateral side surface 401 of trap body 402 facing the side of introduction region 15 has a curved surface. That is, in trap body 402, the edge of lateral side surface 401 facing narrow portion 2 has a curved line. The curved surface means a shape, such as a semi-cylinder and a semi-sphere.

FIG. 8 shows a configuration where lateral side surface 401 of the trap body facing the side of the introduction region has a curved surface convex toward the side of discharge region 16, but the shape of the curved surface is not limited to the above. For instance, as another configuration, lateral side surface 401 of the trap body facing the side of the introduction region may have a curved surface convex toward the side of the introduction region. Lateral side surface 401 of the trap body facing the side of the introduction region may be configured so that a curved surface is partially formed or a plurality of curved surfaces is formed in the lateral side surface.

Trap body 402 is formed so that lateral area S7 of lateral side surface 401 of trap body 402 on the side of introduction region 15 is larger than area S8 of the projection plane of lateral side surface 401 projected along flow channel 4 from the side of introduction region 15 toward the side of discharge region 16 with respect to trap body 402.

In the case of flow channel device 400, lateral side surface 401 formed into a curved surface has an area larger than that obtained by the width of the flow channel between side wall 21 and side wall 22. That is, when area S8 of the projection plane of lateral side surface 401 shown in FIG. 8 is equal to area S4 of the projection plane of lateral side surface 201 shown in FIG. 6B, area S7 of the lateral side surface of trap body 402 on the side of introduction region 15 is larger than area S3.

When lateral side surface 401 is a curved surface, target objects 10 enter the concave portion. Thus, in lateral side surface 401, the vicinities of side walls 21, 22 are less likely to be clogged with target objects 10. Here, the concave portion in trap body 402 indicates the portion where the curved surface protrudes to the side of discharge region 16. In this manner, depending on the place, trap body 402 has a portion that makes narrow portion 2 likely to be clogged with target objects 10 and a portion that makes the narrow portion less likely to be clogged with target objects. Thus, trap body 402 allows more passage of the specimen in narrow portion 2 than trap body 202 that has straight lateral side surface 201 disposed perpendicularly to the flow direction as shown in FIG. 6B. This can reduce an increase in the flow channel resistance caused by clogging of the specimen. Reducing a rapid increase in the flow channel resistance allows the specimen to flow from the side of introduction region 15 toward the side of discharge region 16 even in the state where target objects 10 are trapped in trap body 402 to a certain degree. Thus, more target objects 10 can be captured in trap part 18.

When a curved surface is formed in part of lateral side surface 401 or a plurality of curved surfaces is formed in the lateral side surface and the gap of a concave portion in the curved surface is smaller than the diameter of target object 10, target object 10 does not enter the concave portion in trap body 302. In this case, the specimen goes around from the top and bottom directions of target object 10 and can go through narrow portion 2. This can reduce an increase in the flow channel resistance caused by clogging of the specimen. Reducing a rapid increase in the flow channel resistance allows the specimen to flow from the side of introduction region 15 toward the side of discharge region 16 even in the state where target objects 10 are trapped in trap body 402 to a certain degree. Thus, more target objects 10 can be captured in trap part 18.

Increasing the amount of accumulating target objects 10 in this manner enhances the sensitivity of detecting target objects 10, thus allowing detection using a more simplified detecting device.

### Fourth Exemplary Embodiment

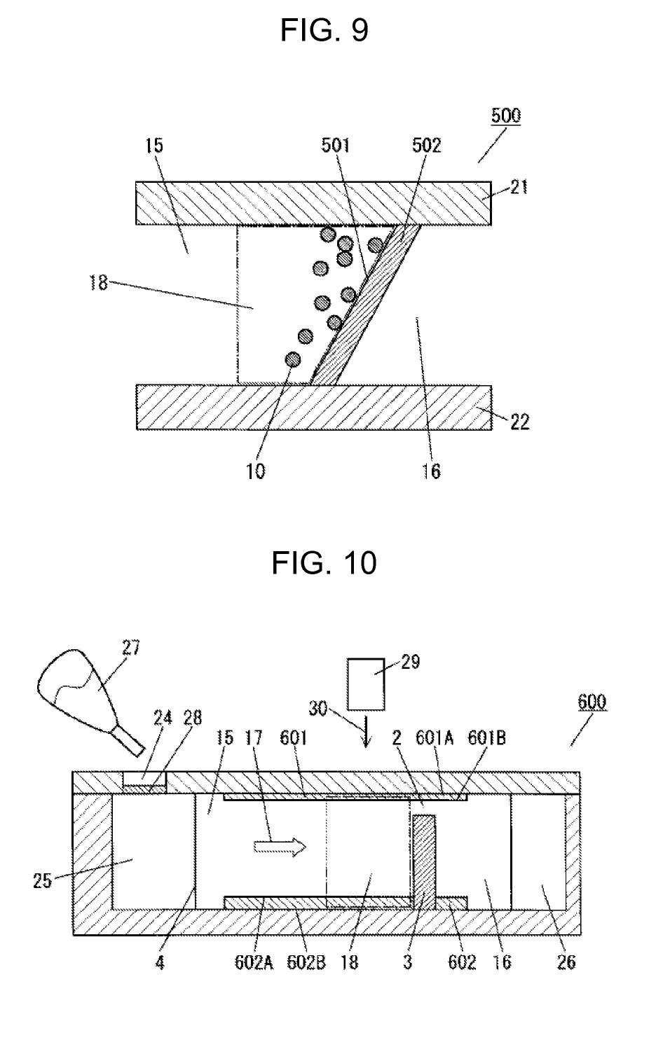

Next, a description is provided for flow channel device 500 in accordance with the fourth exemplary embodiment of the present invention, with reference to FIG. 9. FIG. 9 is a sectional view from the top of flow channel device 500. In this exemplary embodiment, elements similar to those of the first exemplary embodiment have the same reference marks and the descriptions of those elements are omitted in some cases.

In flow channel device 500, lateral side surface 501 of trap body 502 facing the side of the introduction region has an inclined plane. That lateral side surface 501 of trap body 502 facing the side of the introduction region has an inclined plane means a plane that is non-parallel to the flow channel section perpendicular to the flow direction in flow channel 4 is provided. The inclined plane may be formed in the whole or part of lateral side surface 501. That is, lateral side surface 501 has a portion that is non-parallel to the flow channel section perpendicular to the flow direction in the region having the trap body formed therein.

Trap body 502 is formed so that lateral area S9 of lateral side surface 501 of trap body 502 on the side of introduction region 15 is larger than area S10 of the projection plane of lateral side surface 501 projected along flow channel 4 from the side of introduction region 15 toward the side of discharge region 16 with respect to trap body 502.

In the case of flow channel device 500, lateral side surface 501 of trap body 502 facing the side of introduction region 15 is formed into an inclined plane. Thus, lateral side surface 501 of trap body 502 facing the side of introduction region 15 has an area larger than that obtained by the width of the flow channel between side wall 21 and side wall 22. That is, when area S10 of the projection plane of lateral side surface 501 shown in FIG. 9 is equal to area S4 of the projection plane of lateral side surface 201 shown in FIG. 6B, area S9 of the lateral side surface of trap body 502 on the side of introduction region 15 is larger than area S3.

When lateral side surface 501 has an inclined plane, the portion of lateral side surface 501 extending at a small angle with respect to side wall 21 toward the side of discharge region 16 is likely to be clogged with target objects 10. In contrast, the portion of lateral side surface 401 projecting toward the side of introduction region 15 is less likely to be clogged with target objects 10. Here, in FIG. 9 as an example, the portion of lateral side surface 501 extending toward the side of discharge region 16 indicates the vicinity of side wall 21. The portion projecting toward the side of introduction region 15 indicates the vicinity of side wall 22. In this manner, depending on the place, trap body 502 has a portion that makes narrow portion 2 likely to be clogged with target objects 10 and a portion that makes the narrow portion less likely to be clogged with target objects. Thus, trap body 502 allows more passage of the specimen in narrow portion 2 than trap body 202 that has straight lateral side surface 201 disposed perpendicularly to the flow direction shown in FIG. 6B. This can reduce an increase in the flow channel resistance caused by clogging of the specimen. Reducing a rapid increase in the flow channel resistance allows the specimen to flow from the side of introduction region 15 toward the side of discharge region 16 even in the state where target objects 10 are trapped in trap body 502 to a certain degree. Thus, more target objects 10 can be captured in trap part 18.

### Fifth Exemplary Embodiment

Next, a description is provided for flow channel device 600 in accordance with the fifth exemplary embodiment of the present invention, with reference to FIG. 10. FIG. 10 is a side sectional view of flow channel device 600 in accordance with this exemplary embodiment. In this exemplary embodiment, elements similar to those of the first exemplary embodiment have the same reference marks and the descriptions of those elements are omitted in some cases.

Flow channel device 600 is formed of flow channel 4, trap body 3, metal layer 601 disposed on the top wall of flow channel 4, and metal layer 602 disposed on the bottom wall of flow channel 4. Trap body 3 is structured similarly to the trap body in any one of the first through fourth exemplary embodiments. Metal layer 602 is disposed opposite to metal layer 601 with flow channel 4 interposed therebetween. Flow channel device 600 thus has metal layers 601, 602 formed in part of the respective wall surfaces. Each of metal layers 601, 602 is formed of gold, silver, or the like.

Above metal layer 601, that is, in the direction opposite to metal layer 602 with respect to metal layer 601, electromagnetic wave source 29 is disposed. Electromagnetic wave source 29 radiates electromagnetic waves 30 to metal layer 601 from the upper direction of metal layer 601.

Metal layers 601, 602 reflect incident magnetic waves 30 on the top side and bottom side, respectively, of flow channel 4. The user can detect a target object by sensing the interference of the two reflected electromagnetic waves.

Metal layer 601 has a width of approximately 100 nm or smaller. The electromagnetic waves incident on the top face of metal layer 601 are visible light. When metal layer 601 is made of gold, metal layer 601 preferably has a thickness within the range of 35 nm to 45 nm.

When metal layer 602 is made of gold, metal layer 602 preferably has a thickness equal to or larger than 100 nm for the following reason. When the thickness is smaller than 100 nm, the incident electromagnetic waves (visible light) transmit metal layer 602, which decreases the intensity of the electromagnetic waves reflected into the flow channel.

Part of the electromagnetic waves given to top face 601A from the upper direction of metal layer 601 at incident angle θ (θ being defined as an angle between the vertical direction of metal layer 601 and the incident direction of the electromagnetic wave) is reflected by top face 601A and bottom face 601B, and propagates from metal layer 601 upward in the direction of reflection angle −θ. Hereinafter, among the electromagnetic waves incident from the upper direction of metal layer 601, an electromagnetic wave that is reflected by metal layer 601 and propagates from metal layer 601 upward in the direction of angle -0 is referred to as a first electromagnetic wave.

Most of the electromagnetic waves that have not reflected by top face 601A or bottom face 601B of metal layer 601 transmit metal layer 601, propagate through flow channel 4, and reach top face 602A of metal layer 602. When the thickness of metal layer 602 is as sufficiently large as 200 nm or more, all the electromagnetic waves coming from the upper direction of metal layer 602 are reflected by metal layer 602 and propagate in flow channel 4 toward bottom face 601B of metal layer 601 again. Part of the electromagnetic waves that has reached bottom face 601B of metal layer 601 transmits metal layer 601 and propagates from metal layer 601 upward in the direction of angle −θ. Hereinafter, an electromagnetic wave that transmits metal layer 601 from flow channel 4 and propagates from metal layer 601 upward in the direction of angle −θ is referred to as a second electromagnetic wave.

Most of the electromagnetic waves that have reached bottom face 601B of metal layer 601 and not transmitted metal layer 601 are reflected by bottom face 601B or top face 601A of metal layer 601 and propagate downward in flow channel 4 again. Here, in the upper position of metal layer 601, the first electromagnetic wave and the second electromagnetic wave interfere with each other. In particular, when the condition of Equation (1) is satisfied, the waves become weaker. In contrast, when the condition of Equation (2) is satisfied, the waves become stronger.

[Numerical Expression 1]

(m+1/2)*λ=2*n*d*cos θ (1)

where

m: integer

λ: wavelength of electromagnetic wave (in vacuum)

d: thickness of flow channel

n: refractive index in hollow region

θ: angle between vertical direction of metal layer 601 and incident direction of electromagnetic wave

[Numerical Expression 2]

m*λ=2*n*d*cos θ (2)

Such interference conditions can be controlled, depending mainly on the thicknesses of metal layer 601 and metal layer 602, the distance between metal layer 601 and metal layer 602, the refractive index of metal layer 601, the refractive index of metal layer 602, and the refractive index in flow channel 4.

Above top face 601A of metal layer 601, a sensor (not shown) for sensing electromagnetic waves, such as light, is disposed. When flow channel device 1 receives electromagnetic waves 30 given from electromagnetic wave source 29, the sensor receives the electromagnetic waves, such as light, reflected or radiated from flow channel device 1. The sensor is not always necessary. When electromagnetic waves are visible light, the user's eyes can sense changes in the color and intensity of the electromagnetic waves. This configuration can provide a simplified inexpensive sensor device.

Similarly to the first exemplary embodiment, trap bodies 3, 302, 402, 502 shown in the second through fifth exemplary embodiments, respectively, are formed of glass, resin, silicon, transparent plastic, metal, or the like. The wall and each of trap bodies 302, 402, 502 may be made by bonding separately formed elements or may be integrally formed.

In the description of the first through fifth exemplary embodiments, the shape of the lateral side surface of each of trap bodies 3, 302, 402, 502 on the side of discharge region 16 conforms to the shape of the lateral side surface on the side of introduction region 15. The shape of the lateral side surface on the side of discharge region is not limited to this shape. For instance, the lateral side surface on the side of the discharge region may be a plane perpendicular to the flow channel section.

Similarly to the first exemplary embodiment, in the second through fifth exemplary embodiments, the fine particles each of which is immobilized by an acceptor specifically binding to the object to be measured in the specimen and allowing formation of an aggregate may be disposed on a wall surface of flow channel 4 or contained in the specimen.

### INDUSTRIAL APPLICABILITY

A flow channel device of the present invention is capable of extensively accumulating particles to be detected with a simplified configuration and thus has high detection sensitivity. Therefore, the flow channel device can be used as a low-cost bio sensor, for example.

### REFERENCE MARKS IN THE DRAWINGS

1, 200, 300, 400, 500, 600 Flow channel device
2 Narrow portion
3, 202, 302, 402, 502 Trap body
4 Flow channel
5 Top wall
6 Bottom wall
10 Target object
11 Non-target object
12 Medium
15, 215 Introduction region
16, 216 Discharge region
17 Arrow
18 Trap part
21, 22, 221, 222 Side wall
21A, 22A Side surface
20 Projection plane
24 Injection port
25, 26 Reservoir
27 Dropper
28 Filter
29 Electromagnetic wave source
30 Electromagnetic wave
31, 201, 301, 401, 501 Lateral side surface
41 First flow channel
42 Second flow channel
43 Third flow channel
601, 602 Metal layer

1. A flow channel device comprising:
an introduction region for receiving a specimen;
a discharge region for discharging the specimen;
a tubular flow channel having a periphery surrounded by a wall surface; and
a trap body provided in a region between the introduction region and the discharge region in the flow channel so that a narrow portion is formed in the flow channel,
wherein the trap body has a lateral side surface facing the introduction region, and
an area of the lateral side surface of the trap body is larger than a projected area of the lateral side surface projected along the flow channel from the side of the introduction region toward the discharge region.

2. The flow channel device of claim 1, wherein the lateral side surface has two or more planes.

3. The flow channel device of claim 1, wherein an edge of the lateral side surface facing the narrow portion has a wavy line.

4. The flow channel device of claim 1, wherein an edge of the lateral side surface facing the narrow portion has a curved line.

5. The flow channel device of claim 1, wherein the trap body and the wall surface are integrally formed.

6. The flow channel device of claim 1, wherein a metal layer is formed on part of the wall surface.

7. The flow channel device of claim 1, wherein the specimen is a solution of biological origin.

8. The flow channel device of claim 1, wherein the specimen contains a particle in which an acceptor is immobilized, the acceptor binding specifically to an object to be measured in the specimen and forming an aggregate.

9. The flow channel device of claim 8, wherein the narrow portion is larger than the particle and smaller than the aggregate.

10. The flow channel device of claim 1, wherein a particle in which an acceptor is immobilized is disposed on the wall surface, the acceptor binding specifically to an object to be measured in the specimen and forming an aggregate.

11. The flow channel device of claim 10, wherein the narrow portion is larger than the particle and smaller than the aggregate.

12. A flow channel device comprising:
an introduction region for receiving a specimen;
a discharge region for discharging the specimen;
a tubular flow channel having a periphery surrounded by a wall surface; and
a trap body provided in a region between the introduction region and the discharge region in the flow channel so that a narrow portion is formed in the flow channel,
wherein the trap body has a lateral side surface facing the introduction region, and
the lateral side surface of the trap body includes a portion that is non-parallel to a flow channel section perpendicular to a flow direction in the region having the trap body formed therein.

13. The flow channel device of claim 12, wherein the lateral side surface has two or more planes.

14. The flow channel device of claim 12, wherein an edge of the lateral side surface facing the narrow portion has a wavy line.

15. The flow channel device of claim 12, wherein an edge of the lateral side surface facing the narrow portion has a curved line.

16. The flow channel device of claim 12, wherein the trap body and the wall surface are integrally formed.

17. The flow channel device of claim 12, wherein a metal layer is formed on part of the wall surface.

18. The flow channel device of claim 12, wherein the specimen is a solution of biological origin.

19. The flow channel device of claim 12, wherein the specimen contains a particle in which an acceptor is immobilized, the acceptor binding specifically to an object to be measured in the specimen and forming an aggregate.

20. The flow channel device of claim 19, wherein the narrow portion is larger than the particle and smaller than the aggregate.

21. The flow channel device of claim 12, wherein a particle in which an acceptor is immobilized is disposed on the wall surface, the acceptor binding specifically to an object to be measured in the specimen and forming an aggregate.

22. The flow channel device of claim 21, wherein the narrow portion is larger than the particle and smaller than the aggregate.
